(19) United States
(12) Patent Application Publication
(10) Pub. No.: US 2024/0427542 A1
(43) Pub. Date: Dec. 26, 2024

(54) Cloning Display Device Settings

(71) Applicant: Hewlett-Packard Development Company, L.P., Spring, TX (US)

(72) Inventors: Syed S. Azam, Tomball, TX (US); Timothy Paul Guynes, Spring, TX (US); Gregory Staten, Tomball, TX (US)

(21) Appl. No.: 18/339,849

(22) Filed: Jun. 22, 2023

(51) Int. Cl. G06F 3/14; G09G 3/20

(52) U.S. Cl. CPC G06F 3/14; G09G 3/2092; G09G 2354/00; G09G 2370/022

(57) ABSTRACT

Devices and methods for updating display device settings include generating a machine-readable code corresponding to settings of a display device and exporting the machine-readable code to a storage medium. The devices and methods further include initiating import of the machine-readable code to the display device and executing the machine-readable code via control circuitry of the display device to update the settings of the display device.

### BACKGROUND

Electronic displays present visual content to a user, allowing users to view media and/or interact with the media via an internal processor or externally connected processor of an electronic device, such as a personal computer. Furthermore, electronic displays may be coupled to electronic devices that already have built-in displays, such as laptop computers, tablet computing devices, and mobile computing devices like smartphones, to provide additional display space.

Many display devices are configurable, allowing users to adjust settings such as, for example, brightness, color, and contrast. In order to comply with power certifications in certain geographic regions, manufacturers produce display devices with default factory settings, such as reduced brightness settings and/or other disabled functions. Once received, users must reconfigure one setting at a time, on one display device at a time, to adjust display device settings from the factory settings to desired settings. Additionally, when a plurality of display devices are mass deployed, for example, to a company, lengthy, individual firmware updates are required to configure all of the display devices to fit a desired deployment setting scheme, and many models of display devices require the use of special hardware and software to perform such updates.

### BRIEF DESCRIPTION OF THE DRAWINGS

FIG. 1 is a diagram of a display device displaying example configurable settings.

FIG. 2 is a diagram of an example display device and an example external storage device including a file associated with configurable settings of the display device.

FIG. 3 is a diagram of a host electronic device uploading a configurable setting of a display device to a network to distribute the configurable setting to display devices connected to the network, according to an example implementation.

FIG. 4 is a diagram of an application for generating and exporting a configurable setting of a display device to a network to distribute the configurable setting to display devices connected to the network, according to an example implementation.

FIG. 5 is a method for altering a configurable setting of a display device according to an example implementation.

FIG. 6 is another method for altering a configurable setting of a display device according to an example implementation.

FIG. 7 is yet another method for altering a configurable setting of a display device according to an example implementation.

FIG. 8 is yet another method for altering a configurable setting of a display device according to an example implementation.

FIG. 9 is yet another method for altering a configurable setting of a display device according to an example implementation.

FIG. 10 is yet another method for altering a configurable setting of a display device according to an example implementation.

FIG. 11 is yet another method for altering a configurable setting of a display device according to an example implementation.

### DETAILED DESCRIPTION

Electronic devices are used by millions of people daily to carry out business, personal, and social operations and it is not uncommon for an individual to interact with multiple electronic devices on a daily basis. Examples of electronic devices include, but are not limited to, desktop computers, laptop computers, all-in-one devices, and gaming systems. Display devices, such as monitors, can be coupled to these electronic devices to present visual information to a user. Furthermore, in some applications, a display device may not be coupled to an electronic device, but may still present visual content to a user as a stand-alone display device. For example, the display device may again be a monitor, as well as a television, a projector, a mobile device such as a smartphone, or a tablet. While particular reference may be made to particular display devices throughout the present disclosure, the term “display device” may refer to any variety of device that is capable of displaying visual content.

Accordingly, a display device may include hardware components that are configured to present content to the user and provide additional functionalities. For example, a display device may include, but is not limited to, a screen, pixel arrays, backlights, and/or a glass panel, among other components, arranged to present content to a user. Furthermore, a display device may include a wireless transceiver to connect to a network (e.g., the internet, a local area network, etc.) to facilitate interaction with the display device, such as downloading and uploading files and media. As another example, a display device may include control circuitry and a user interface, such as one or more buttons, that allows a user to interact with the display device to configure settings associated with the display device.

Display devices are subject to certain standards in different geographic regions, for example, that limit the allowed power consumption of the display devices when shipped. As such, display device manufacturers may sell display devices with firmware containing a factory setting scheme, in which the one or more settings are configured to adhere to such power standards. In one example, a factory-set maximum brightness setting, measured in candelas per square meter (cd/m2) or nits (nts), is set at a reduced or minimum level. In another example, certain functionality may be disabled or turned off to reduce power consumption.

While the factory setting scheme complies with such standards, it does not take into account user-desired settings and user experience while using the display device. For example, when a user purchases and turns on a display device for the first time, or after performing a factory reset of the display device, the user may be disappointed with the low brightness of the display device. Thus, once deployed, the user will often re-configure the settings to their likeness. It should be noted that, though the above example uses display brightness as a configurable setting that a user may want to alter, display devices may include tens, hundreds, or thousands of configurable settings that allow the user to perfect their experience when using a display device. For example, in some professions such as graphic design, video rendering, or the like, where visual accuracy is particularly relevant, correct color, color contrast, and display brightness are all settings particular to the user's experience and work product.

Additionally, in some instances, companies may have a plurality of display devices, often connected via a network. Such companies may include their own set of desired settings, different from the factory setting scheme. Traditionally, in order to configure the plurality of display devices to obtain these desired settings, a user, such as an IT professional of the company, must complete a firmware update on each display device to separately configure each setting, resulting in a lengthy set-up process before the display devices can be deployed to employees. The present disclosure provides a process for efficiently updating the configurable settings for display devices individually or en masse.

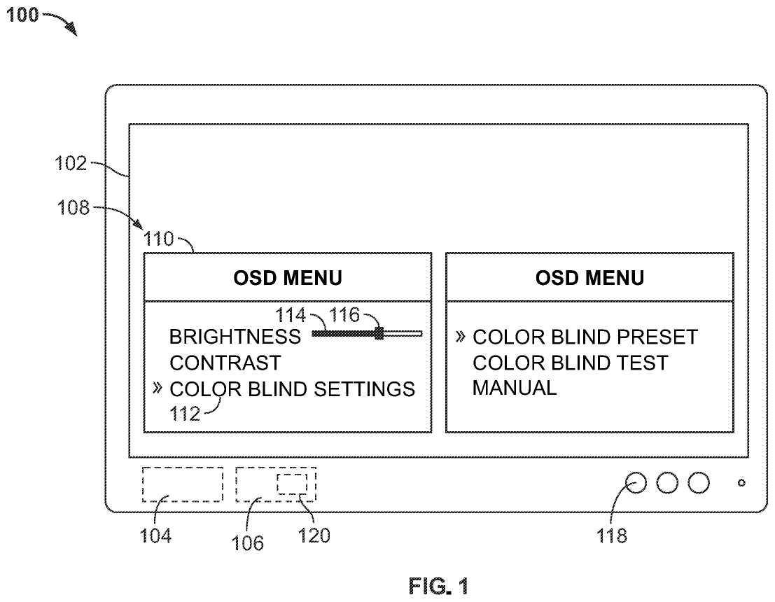

Turning now to the figures, FIG. 1 illustrates an example display device 100, which can include a display 102, display control circuitry 104, and storage media 106. The display device 100 may be, but is not limited to, an external monitor, an electronic device display, a television, a tablet display, a projector, or a laptop computing device display, among others. The display 102 of the display device 100 displays visual content and may be of a variety of types. For example, the display 102 may be, but is not limited to a liquid crystal display (LCD), a light-emitting diode (LED) display, an organic LED (OLED), or a plasma display.

The display control circuitry 104 can be, for example, a processor, a controller, an Application Specific Integrated Circuit (ASIC), or other logic. Furthermore, the storage media 106 may be communicatively coupled to the display control circuitry 104 and contain machine-readable code, programs, or data stored thereon. The machine-readable code, programs, and/or data may be in the form of instructions provided to the display control circuitry 104 for performing a specific function. In some configurations, the instructions may cause the display control circuitry 104 to alter the function of a hardware component of the display device 100, such as the display 102. For example, the display control circuitry 104 can execute machine readable instructions to cause the display device 100 to generate an on-screen display (OSD) 108 through the display 102, as shown in FIG. 1.

While the display control circuitry 104 and the storage media 106 are illustrated as being physically placed within the display device 100 in FIG. 1, in some implementations, display control circuitry 104 and/or the storage media 106 may be communicatively coupled to the display device 100 and physically located at an electronic device, such as a personal computer (not shown in FIG. 1) associated with the display device 100. In further implementations, both the display device 100 and the electronic device may include processors 104, which may cooperate in order to accomplish the functionality of the display device 100, as described herein. Additionally, in some configurations, the display control circuitry 104 may contain a wireless transceiver (not shown), such as a Bluetooth®, Wi-Fi, or other wireless transceiver, so a user may export or import files in a wireless manner, as discussed further below.

Generally, the display control circuitry 104 can generate the OSD 108 through the display 102, receive an input via the OSD 108, and update a setting of the display device 100 based on the input. More specifically, as shown in FIG. 1, the OSD 108 may include a menu 110, or multiple menus 110. The menus 110 may allow a user to select a setting 112 that can be set or altered. Example settings 112 may include, but are not limited to, brightness, color, contrast, image quality (e.g., 1080p), language, sleep timer, refresh rate, among other options. Accordingly, settings 112 may be associated with physical attributes of the display device 100 as well as functions of the display device 100. In some configurations, the menus 110 may include adjusters 114 that allow a user to alter a value, such as a setpoint 116, of a respective setting 112. FIG. 1 illustrates one adjuster 114 as a slider, however the adjusters 114 may be any interface, such as buttons, check-boxes, data fields, drop down menus, textboxes, and the like that allows the user to set a respective setting 112 to a setpoint 116. The setpoint 116 may include a number or text that determines a characteristic of the setting 112. For example, a brightness setting may include the setpoint 116 that is adjustable along a scale of 0 to 100. As another example, a setting 112 may include a setpoint 116 as “on” or “off,” or “disabled” or “enabled.” a specific language, etc. In response to the user input, the display control circuitry 104 can carry out certain functions associated with the setting 112 based on the setpoint 116 (e.g., in response to a user altering a setpoint 116 for a brightness setting 112, the display control circuitry 104 may alter a brightness of the display 102).

Still referring to FIG. 1, in some configurations, a user may interact with the OSD 108 via a user interface, such buttons 118 disposed on the display device 100. The buttons 118 may allow the user to navigate the menus 110 and/or select one of the settings 112 from the menus 110 to alter. The buttons 118 may further allow the user to interact with the adjusters 114 to adjust the setpoint 116 of the selected setting 112. In some implementations, the user may also interact with the OSD 108 via a touch-screen interface on the display 102. As such, the user can select one of the settings 112 from the menus 110 to alter, and may further interact with the adjusters 114 to change the setpoint 116 of the selected setting 112 by physically interacting with the touch-screen interface. In further implementations, a user may interact with the OSD 108 via an external device, such as a computer mouse or joystick (not shown), connected directly to the display device 100 (e.g., in a wired or wireless manner) or through a connected electronic device.

Additionally, while the settings 112 are described herein as being accessible for reconfiguring via the OSD 108, in some implementations, additional non-OSD menus may be accessed to reconfigure certain settings 112. For example, menus containing settings 112 that can be altered may be accessed through a connected electronic device (e.g., a personal computer) coupled to the display device 100 via an application stored on and executed by electronic device or a web application accessed via a connected network.

In some configurations, each setting 112 may be assigned a respective code. For example, some configurable settings of display devices 100 are standardized by Monitor Control Command Set (MCCS), a computer standard developed by Video Electronics Standards Association (VESA). More specifically, MCCS defines a binary protocol for controlling the properties of monitors, where each command entity, or setting, in the MCCS language is associated with a binary virtual control panel (VCP) code. VCP codes include, but are not limited to, commands for restoring factory defaults, color adjustment, geometry adjustment, image adjustment, audio adjustment, and more. Each VCP code may be contain a variable number of data parameters and/or command attributes, e.g., “feature codes,” for altering the setting 116 associated with the VCP code. In a theoretical example, altering the feature code of a VCP code from “A” to “B” may alter a brightness of a display on the display device. In addition to binary VCP codes assigned to certain settings 112, some display devices can include additional codes, such as hexadecimal codes assigned to additional settings 112.

Accordingly, in some implementations, each of the settings 112 of the display device 100 may be associated with a respective code. However, in other implementations, only some settings 112 may be associated with a code (e.g., such implementations may only include VCP codes associated with some settings 112 and not include non-VCP codes associated with other settings 112). Furthermore, altering a setpoint 116 of a setting 112 alters the feature code associated with the code assigned to the setting 112. In other words, each of the feature codes may be an alterable value that at least stores the setpoint 116 of the setting 112. For example, a first VCP code may be associated with a brightness of the display 102, while a second VCP code may be associated with a maximum brightness value of the display 102. In the provided example, the feature code of the first VCP code may be altered to change and store the setpoint 116 of the brightness of the display 102. Furthermore, the feature code of the second VCP code may be altered to increase or decrease the setpoint 116 of the maximum brightness value (in nits) of a maximum setting of a brightness scale.

As noted above, settings 112 may include, but are not limited to, OSD settings such as brightness, color, contrast, image quality, language, sleep timer, refresh rate. Further example settings 112 may include pop-up options (e.g., disabling or enabling certain pop-ups following a user action), function accessibility (e.g., hiding/unhiding certain configurable options), location (e.g., a location or region where the display device 100 will be deployed), etc. Accordingly, while each setting 112 can be associated with a certain code, the respective feature codes for each code may correspond to a single setpoint 116 (e.g., a single value such as a number or on/off, disable/enable command, etc.) or may correspond to multiple setpoints 116 (e.g., such that certain settings 112 may affect an additional setting(s) 112 and/or feature(s) of the display device 100). By way of example, in some configurations, setting the location setting 112 to a certain location or region automatically updates a plurality of other settings 112 including, but not limited to, language settings, brightness settings, etc. As another example, setting the set maximum brightness value setpoint 116 affects the possible setpoint 116 a user may be able to select for the brightness value setting 112.

Referring again to FIG. 1, in some configurations, the storage medium 106 may store data associated with the code(s) and the feature code(s) associated with each setting 112. For example, the storage medium 106 may store a digital file 120 that contains all codes and associated feature codes of a current settings scheme for at least one, at least five, at least ten, at least twenty, at least fifty, at least one-hundred, or all of the settings 112 of the display device 100. That is, the current settings scheme may refer to the current setpoints 116 for some or all settings 112 of the display device 100. The file 120 may be stored as machine-readable code, that is, machine-readable instructions for a display control circuitry 104 to configure the settings 112 as defined by the feature codes. Thus, the file 120 may be any type of machine-readable file, such as a text file, .XML file, .CSV file, or other type of data file. For example, in one configuration, the file 120 may include a list of codes and associated feature codes.

As described above, each feature code may include at least the setpoint 116 of the respective setting 112. When a setpoint 116 is altered, e.g., by a user interacting with the OSD 108, the current settings scheme, and the file 120, may be updated accordingly. Thus, the display control circuitry 104 can generate the OSD 108 through the display 102, receive an input via the OSD 108, and update a setting 112 based on the input, as discussed above, and can further generate a machine-readable code corresponding to the updated setting 112 to be stored in the file 120.

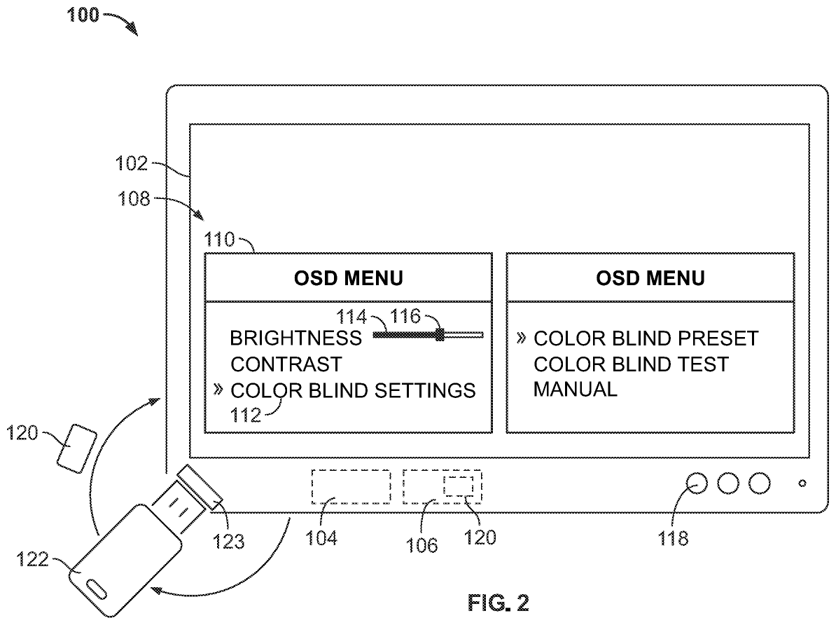

In some implementations, the file 120 may be exported from a display device 100 to an external storage medium so that the current settings scheme of the display device 100 can be imported to other display devices 100, allowing the current settings of the display device 100 to be “cloned” onto other display devices 100. That is, the file 120 may be imported by a “recipient” display device 100 and the display control circuitry 104 of the recipient display device 100 can configure its settings 112 according to the current settings scheme by executing the machine-readable code. Accordingly, the file 120 may contain the machine-readable code implemented in a manner that is readable and executable by recipient display devices 100, which may be the same as, similar to, or different from the “host” display device 100 (e.g., different model, different manufacturer, etc.). This may be in contrast to, for example, firmware update files, which are application- and device-specific, such that they cannot be used on different models or even different devices of the same model. In one example, as noted above, the file 120 may be a text file of machine-readable code comprising a list or table of codes and associated feature codes. Therefore, in comparison to a user accessing and altering individual settings via, for example, an OSD 108 or performing a firmware update on the recipient display device 100 to achieve a desired settings scheme, the user may instead import and execute the file 120 so that the display control circuitry 104 of the recipient display device 100 updates the settings 112 according to the current settings scheme saved in the file 120. FIGS. 2-11 illustrate non-limiting examples of this functionality.

Accordingly, referring now to FIG. 2, in some configurations, the display device 100 may be configured to be coupled to and communicate bidirectionally with an external storage medium 122. In some implementations, the external storage medium 122 may be a form of physical storage media external to the display device 100 such as, but not limited to, an individual USB device, as shown in FIG. 2, an external hard drive, etc. or a storage medium associated with an electronic device, such as a computer, a mobile phone, a tablet, etc. Accordingly, in some configurations, the display device 100 may include a port 123 that provides a connection between the display control circuitry 104 and the external storage medium 106. In the example shown in FIG. 2, the port 123 may be a USB port configured to receive a USB device. The external storage medium 122 may store digital files, including the file 120 containing machine-readable code with a current settings scheme. As discussed above, in some configurations, the current settings scheme may include a setpoint 116 for each setting 112 of a display device 100, stored as feature codes associated with respective codes. In some configurations, the current settings scheme may include a setpoint 116 for only some of the settings 112.

In some configurations, the file 120 containing the current settings scheme may be exported from a display device 100 (e.g., a “host” display device 100) to the external storage medium 122. For example, the file 120 may be downloaded from the host display device 100 to the external storage medium 122. In that manner, the external storage medium 122 stores the file 120 containing a current settings scheme reflecting settings 112 that match that of the display device 100. In further configurations, a file 120 containing the current settings scheme may be imported onto a recipient display device 100 from the external storage medium 122. For example, a user may initiate import by connecting the external storage medium 122 to the recipient display device 100. The display control circuitry 104 of the recipient display device 100 may then execute the machine-readable code of the file 120 and replace the feature codes of an existing settings scheme already stored within the recipient display device 100 with feature codes of the current settings scheme and, in turn, alter the setpoint 116 of respective settings 112 of the recipient display device 100.

Accordingly, the external storage medium 122 may be used to export the machine-readable code from a first, or host, display device 100 and then import the machine-readable code to an additional, or recipient, display device 100 to alter setpoints 116 of settings 112 of the recipient display device 100 to match those of the host display device 100. In this manner, the external storage medium 122, using an import/export method with machine-readable code, may act as a quick and efficient method to transfer a settings scheme from one display device 100 to a plurality of other display devices 100. The aforementioned method may provide users and IT professionals a process that quickly copies a current settings scheme across multiple display devices 100 without updating firmware to individually alter settings of each display device 100. Rather, the user needs only to initiate import of the file 120 to the recipient display device 100, e.g., by connecting the external storage media 122 to the display device 100, and allow the display device 100 to execute the machine-readable code of the file 120.

Additionally, in some configurations, the external storage medium 122 may be connected to more than one display device 100 to upload and install the current settings scheme to multiple display devices 100 at once. Using the example of FIG. 2, multiple display devices 100 can be coupled together. Therefore, when the file 120 is imported into a first display device 100 from the external storage medium 122, the file 120 can be further uploaded to a connected second display device 100 via the first display device 100. Alternatively, the first display device 100 and the second display device 100 can be connected in a manner where their respective settings schemes are mirrored. As a result, when the first display device 100 imports and executes the machine-readable code of the file 120 from the external storage medium 122, any settings 112 that are updated on the first display device 100 are also updated on the second display device 100.

Referring back to FIG. 2, FIG. 2 illustrates the external storage medium 122 directly, physically coupled to the display device 100. In some implementations, however, the external storage medium 122 may instead be physically coupled to an electronic device, such as a computer, which is coupled to the display device 100. For example, in some implementations, the display device 100 may not include the hardware capabilities to receive the external storage medium 122 (e.g., the display device 100 may not include a USB hub/port to receive a USB device storing the file). As such, the processors 104 of the display device 100 and the associated electronic device may cooperate to import and/or export the file 120 and update settings 112 to match the current settings scheme.

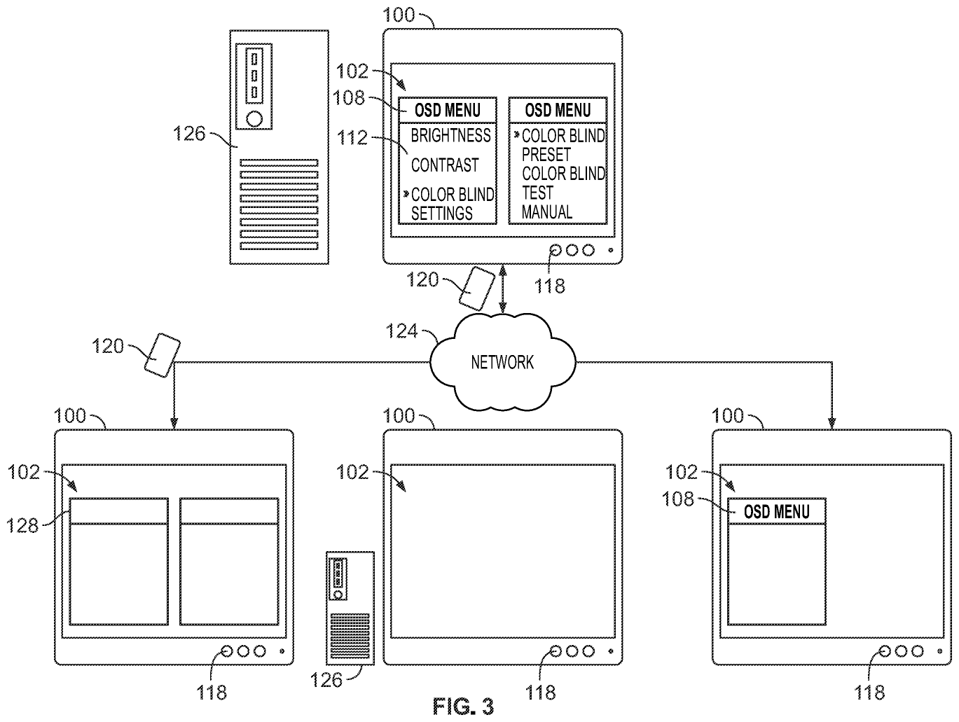

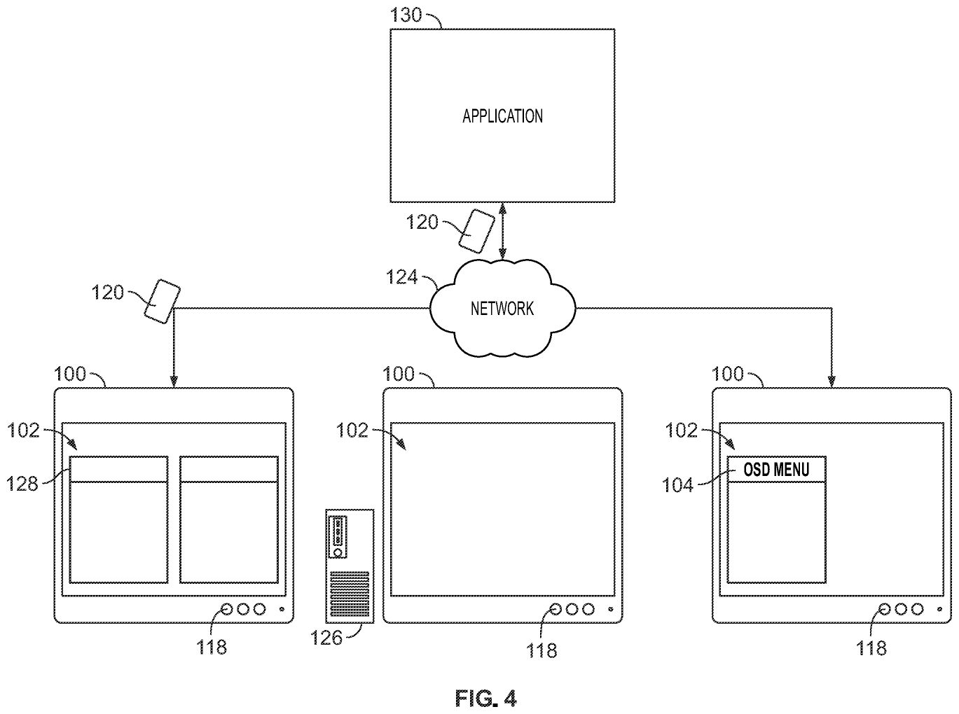

Turning now to FIGS. 3 and 4, some configurations may employ virtual import/export methods, where physical connection to the external storage medium 122 storing the file 120 may not be necessary. More specifically, FIG. 3 illustrates a first, host display device 100 and a plurality of second, recipient display devices 100 connected via a network 124, such as the internet, a local area network, a wide area network, etc. As shown in FIG. 3, the host display device 100 may be coupled to an electronic device 126. Accordingly, reference herein to the host display device 100 may further refer to a host electronic device 126, and vice versa. A file 120 containing machine-readable code corresponding to the current settings scheme of the display device 100 may be generated via the display control circuitry 104 and/or a processor of the electronic device 126. For example, a user can configure the settings 112 via the OSD 108 through the display device 100 or by interacting with another software application via the electronic device 126 configured to update settings 112 of the display device 100. Once the file 120 is generated, the file 120 may be exported from the host display device 100 to the network 124 (where a “storage medium” according to this example may be network-based or cloud-based storage), and may be imported from the network 124 onto a recipient display device 100.

In this manner, a user may initiate import to the recipient display devices 100 by either sending the file 120 to select recipient display devices 100 over the network 124 from the host device 100 or by requesting or pulling the file 120 off the network from a recipient display device 100 (e.g., through the OSD 108 or another application 128 on the display device 100). As shown in FIG. 3, each recipient display device 100 may be a stand-alone display device 100 or may be coupled to an associated electronic device 126. Once imported, the machine-readable code stored on the file 120 can be executed by the display control circuitry 104 (and/or a processor of the associated electronic device 126) to update a setting 112 of the recipient display device 100 according to the current settings scheme.

According to the example of FIG. 3, a current settings scheme of the host display device 100 can be exported to the recipient display devices 100 over the network 124 so that the settings on the recipient display devices 100 match those of the host display device 100. Referring now to FIG. 4, in some configurations, a display device 100 or other electronic device 126 may be used to generate a file 120 containing machine-readable code related to a current settings scheme via an application 130. The application 130 may be, for example, a software application stored on and executed by the display device 100 and/or the electronic device 126, an application integrated into the OSD 108 of the display device 100, or a web-based application accessed by the display device 100 and/or the electronic device 126. According to the example shown in FIG. 4, the current settings scheme may not match the settings of the display device 100 but rather, is a separately generated file 120 according to settings and setpoints selected by the user through the application 130. Furthermore, according to the example shown in FIG. 4, a separate display device 100 may not be necessary to update settings and/or generate a file 120 but, rather such steps may be completed though a host electronic device 126, which may have a connected display device 100 or include an integrated display.

As noted above, in some implementations, the application 130 may be, for example, a web application accessed by the display device 100 or an electronic device 126 through a network, or may be a software application stored on the display device 100 or a connected electronic device 126 and executed by the display control circuitry 104 and/or processor of the electronic device 126. Generally, in some configurations, the application 130 may display an interface that permits a user to select specific settings 112 and setpoints 116 for such settings 112, in which a file 120 of respective machine-readable code can be generated, e.g., with respective codes and associated feature codes assigned to settings 112, as described above. For example, the application 130 may display menus similar to the OSD 108, with adjusters 114 for altering setpoints 116, or may include a different graphical user interface. Once generated via the application 130, a user may be given the option to export the file 120 to an external storage medium 122 or the network 124.

In some configurations, through the application 130, a user may export the generated file 120 to the network to be directly sent to and imported by a recipient display device 100. In further configurations, the user may interact with the application 130 through the recipient display device 100 to select and import a generated file 120. In either configuration, the machine-readable code in the file 120 may be executed via display control circuitry 104 of a recipient display device 100 and/or a processor of a connected electronic device 126 to update a setting 112 of the recipient display device 100 according to the current settings scheme selected through the application 130. The recipient display device 100 may automatically or selectively download and execute the file 120 to update its settings 112 according to the current settings scheme.

In light of the above, according to any of the configurations of FIGS. 2-4, a host display device 100 (or a host electronic device 126) can receive an input corresponding to a current settings scheme (e.g., via the OSD 108 or the application 130), generate a machine-readable code corresponding to the current settings scheme, and export the machine-readable code to a storage medium (e.g., a physical external storage medium 122 or network storage 124). Further, a recipient display device 100 or electronic device 126 can import the machine-readable code and execute the machine-readable code to update settings 112 of a recipient display 102 associated with the recipient display device 100. In some configurations, the current settings scheme may include a plurality of settings 112, which are each associated with a specific code and respective feature codes according to the setpoint of the setting 112. These codes may include standard, binary VCP codes or non-VCP codes.

In some implementations, when the machine-readable code is executed by a recipient display device 100, the recipient display device 100 may only alter settings 112 associated with known codes on the display device 100. For example, if the recipient display device 100 does not recognize non-VCP codes, the recipient display device 100 may only alter settings 112 associated with VCP codes according to the current settings scheme and ignore the non-VCP codes within the file 120. Accordingly, in some configurations, the recipient display device 100 may alter settings 112 associated with all recognizable codes in the file 120. Furthermore, in some configurations, one setting 112, or code, may correspond to a make or model of the display device 100, where the recipient display device 100 may only alter settings 112 in the file 120 associated with its make or model type.

Additionally, in some implementations, when the machine-readable code is generated corresponding to the current settings scheme, a user may be given the option to export only a portion of the machine-readable code to the file 120. For example, a user may export a portion of the machine-readable code only corresponding to settings 112 that have been altered on the host display device 100 from default settings. As a result, when the machine-readable code is imported and executed by a recipient display device 100, only those settings 112 which were altered on the host display device 100 are altered on the recipient display device 100. In this manner, other settings 112 of the recipient display device 100 remain unaffected when the machine-readable code is executed. As a result, if such settings 112 were already altered on the recipient display device 100, they remain at their altered setpoint 116 rather than being returned to their default setpoint 116 according to the current settings scheme of the host device 100. This type of “partial cloning,” as opposed to a “full cloning,” may be advantageous for users who wish to retain the setpoints 116 of some of the settings 112, while quickly altering the setpoints 116 of other settings 112.

Accordingly, in some configurations, a user, through the host display device 100 may be given the option to export the file 120 containing setpoints 116 for only some settings 112. Furthermore, in some configurations, a user, through the recipient display device 100, may be given the option to update setpoints 116 for only some settings 112. For example, through the OSD 108 or one of the applications 128, 130, a user may be able to select settings 112 to be updated according to the current settings scheme stored in the file 120. In this manner, a user may also be able to revert back to the current settings scheme, e.g., rather than factory default settings, if certain settings 112 were individually altered, by accessing the file 120 through the OSD 108 or one of the applications 128, 130.

Furthermore, in some configurations, the file 120 may include security measures or checksum methods to ensure authenticity of the file 120, for example, so that hackers or others with ill-intentions are unable to change the settings 112 of the display device 100 or so that the file 120 does not leave the display device 100 in a corrupted or unreadable state. In one configuration, the file 120 may include a digital signature to authenticate the file 120. For example, in some configurations, the display device 100 may refuse to upload and/or install the current settings scheme stored on the file 120 without a verified digital signature.

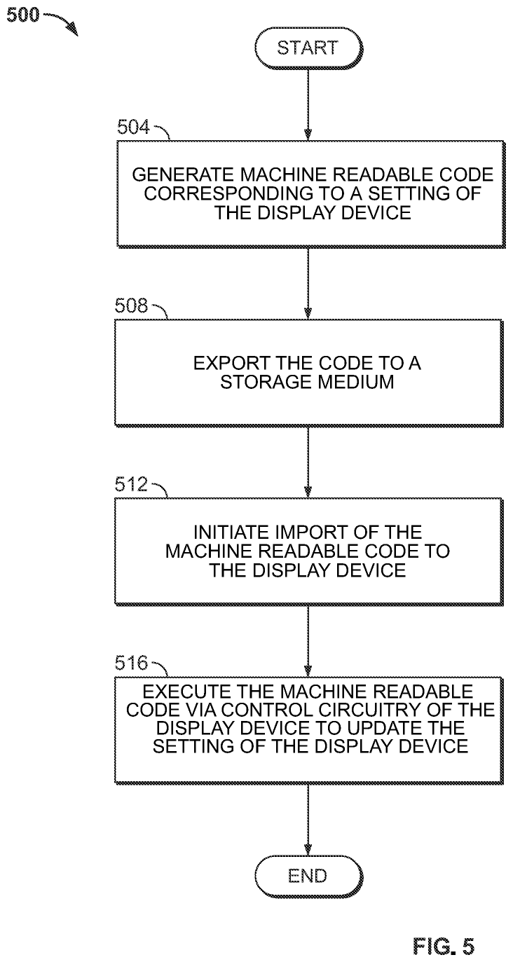

In light of the above, FIGS. 5-11 illustrate example methods for updating a setting on a display device 100 according to some implementations. As further described below, generally, each of the methods includes exporting a file containing machine-readable code associated with a current settings scheme and initiating import of the file to a recipient display device to update settings of the recipient display device according to the current settings scheme. It should be noted that, while each method in FIGS. 5-11 is shown and described as having certain method steps in a specific order, in some implementations, the method may include fewer or more steps, steps in a different order, and/or two or more steps performed simultaneously. Additionally, it should be noted that, while each method in FIGS. 5-11 is described as having certain method steps associated with a setting or a display device, such method steps may be associated with a plurality of settings or a plurality of display devices. In some implementations, such method steps may be considered to be carried out for a plurality of settings or a plurality of recipient display devices as described below. In other implementations, certain method steps may be repeated simultaneously or concurrently to be considered to be carried out for a plurality of settings or a plurality of recipient display devices.

Referring now to FIG. 5, an example method 500 is illustrated for updating a setting on a display device. At step 504, machine-readable code corresponding to a setting of a display device is generated. At step 508, the machine-readable code is exported to a storage medium. At step 512, the method 500 includes initiating import of the machine-readable code to a recipient display device. As described above, initiating import may include physically connecting the storage medium to the recipient display device, sending the machine-readable code to the recipient display device over a network, or retrieving the machine-readable code from the network by the recipient display device. At step 516, the method 500 includes executing the machine-readable code via a processor (e.g., display control circuitry) of the recipient display device to update the setting of the display device.

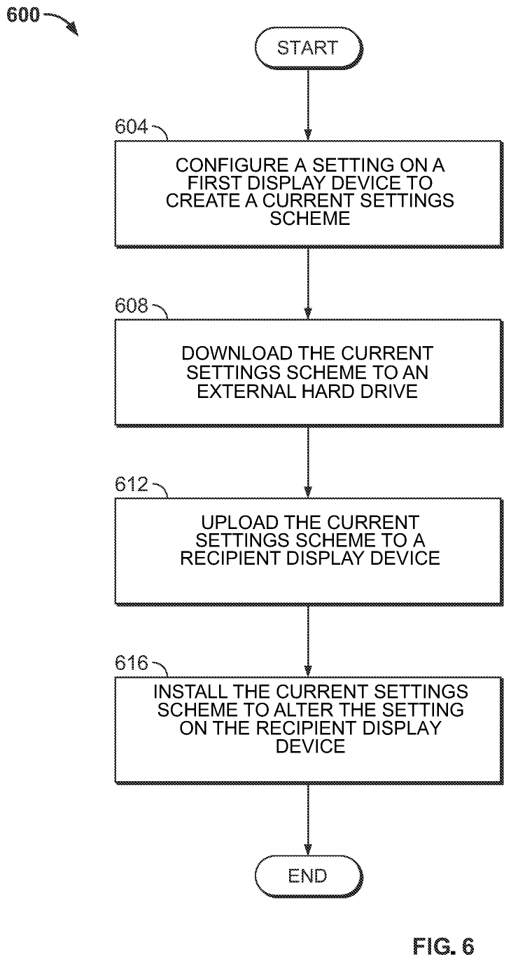

Referring now to FIG. 6, another example method 600 is illustrated for updating a setting on a display device. At step 604, the method 600 includes configuring a setting on a first display device to create a current settings scheme. At export step 608, the method 600 includes downloading the current settings scheme, in the form of a file containing machine-readable code, to an external hard drive (e.g., an external storage medium). At import step 612, the method 600 includes uploading the file to a recipient display device, e.g., by connecting the external hard drive to the recipient display device. At step 616, the method 600 includes installing the current settings scheme (e.g., by executing the code) to alter a recipient display device setting on the recipient display device.

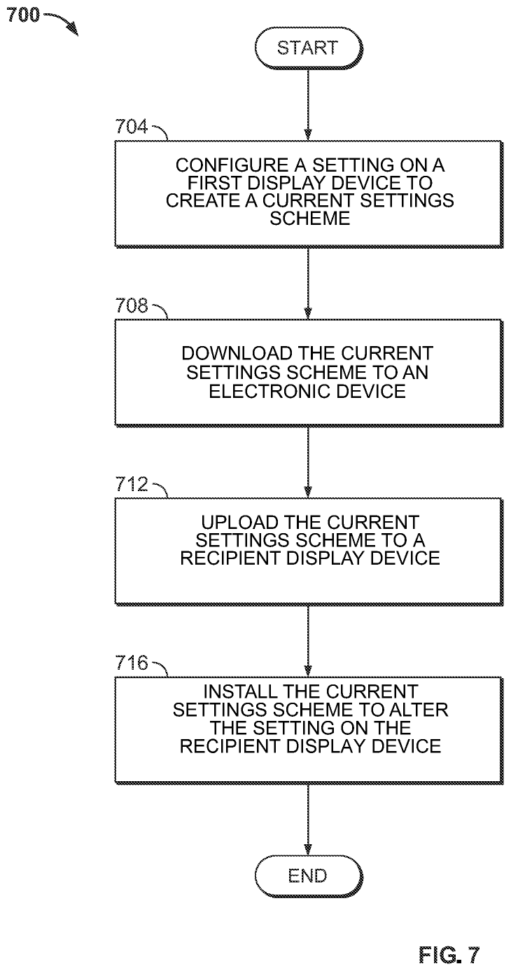

Referring now to FIG. 7, another example method 700 is illustrated for updating a setting on a display device. At step 704, the method 700 includes configuring a setting on a first display device to create a current settings scheme. At export step 708, the method 700 includes downloading the current settings scheme, in the form of a file containing machine-readable code, to an electronic device (e.g., an external storage medium in the form of storage media of the electronic device). As discussed above, the electronic device may be a personal computer, a mobile phone, a tablet, etc. At import step 712, the method 700 includes uploading the file from the electronic device to a recipient display device, e.g., by connecting the electronic device to the recipient display device physically or through a wireless connection. At step 716, the method 700 includes installing the current settings scheme (e.g., by executing the code) to alter the setting on the recipient display devices.

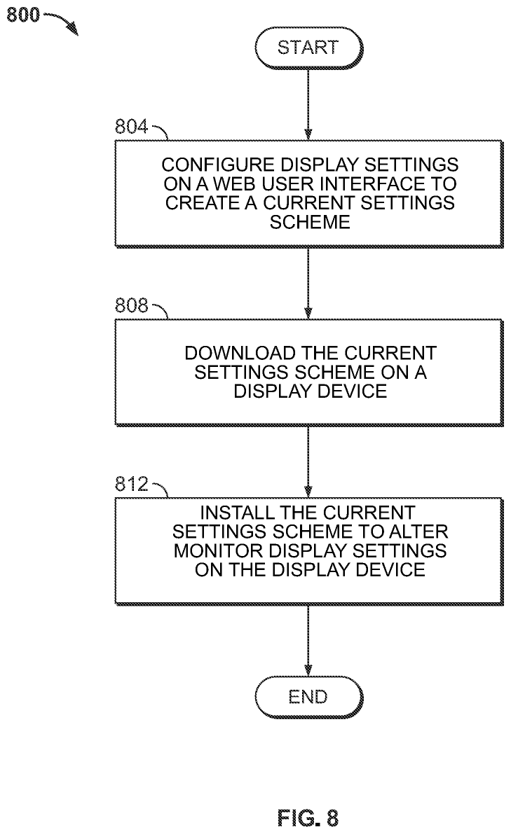

Referring now to FIG. 8, another example method 800 is illustrated for updating a settings on a display device. At step 804, the method 800 includes configuring a display setting on a web application user interface to create a current settings scheme. At export/import step 808, the method 800 includes downloading the current settings scheme, in the form of a file containing machine-readable code, on an electronic device. At step 812, the method 800 includes installing the current settings scheme (e.g., by executing the code) to alter a display device setting on a display device.

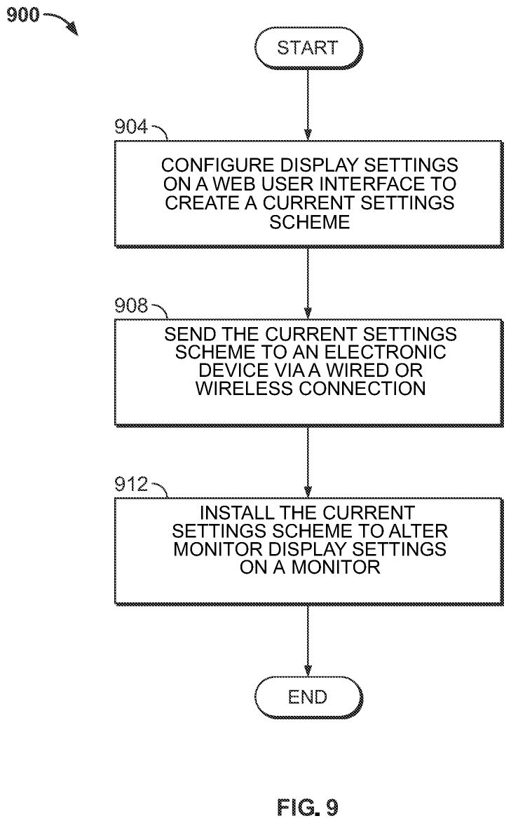

Referring now to FIG. 9, another example method 900 is illustrated for updating a setting on a display device. At step 904, the method 900 includes configuring a display setting on a web application user interface to create a current settings scheme. At export/import step 908, the method 900 includes sending the current settings scheme, in the form of a file containing machine-readable code, to an electronic device via a wired or wireless connection. At step 912, the method 900 includes installing the current settings scheme (e.g., by executing the code) to alter a display device setting on a display device.

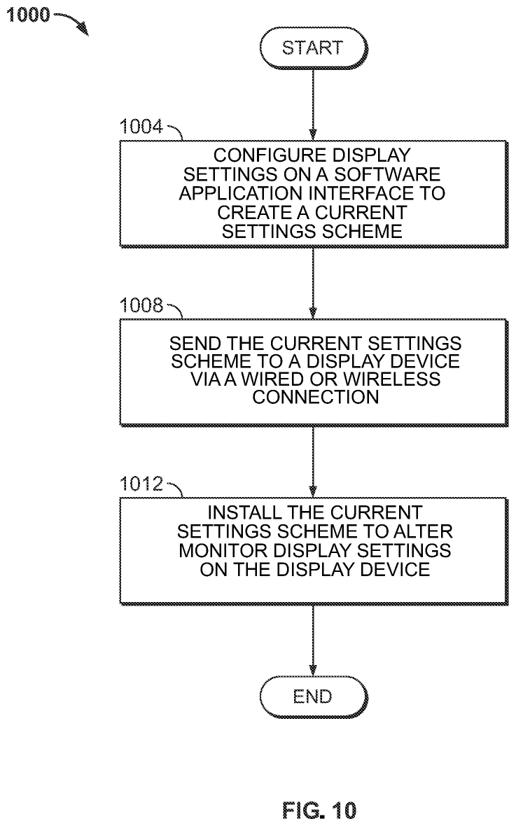

Referring now to FIG. 10, another example method 1000 is illustrated for updating a settings on a display device. At step 1004, the method 1000 includes configuring a display setting on a software application interface to create a current settings scheme. At export/import step 1008, the method 1000 includes sending the current settings scheme, in the form of a file containing machine-readable code, to an electronic device via a wired or wireless connection. At step 1012, the method 1000 includes installing the current settings scheme (e.g., by executing the code) to alter a display device settings on a display device.

This method 1000 (or any of the methods herein) may be beneficial for large-scale customers such as employers wanting to deploy an employer settings scheme across display devices for all employees. A user, such as an IT professional, may be able to create the employer settings scheme through the software application (or the web application of the method 900), may further be able to view and select any number of employee monitors, e.g., connected via a network, and deploy the employer settings scheme to all selected monitors. In some cases, deployment and install steps 1008 and 1012 may be performed “behind the scenes” without requiring end-user intervention via the employee monitor.

This method 1000 (or any of the methods herein) may also be beneficial on a manufacturing level. For example, as described above, various locations have different power certifications that must be adhered to. As such, manufacturers often create display devices with firmware containing a settings scheme adapted for the intended supply location. If such display devices would need to be rerouted to a different location with different power certifications, the display devices would require firmware updates to reconfiguration the settings scheme according to the new location. According to some implementations, one setting of the display devices may be a location setting, and the associated feature codes of the code for that setting may correspond to all other settings necessary to comply with power certifications associated with that location. Thus, by generating a file altering the location settings and deploying the file to display devices, location-based firmware updates may not be necessary.

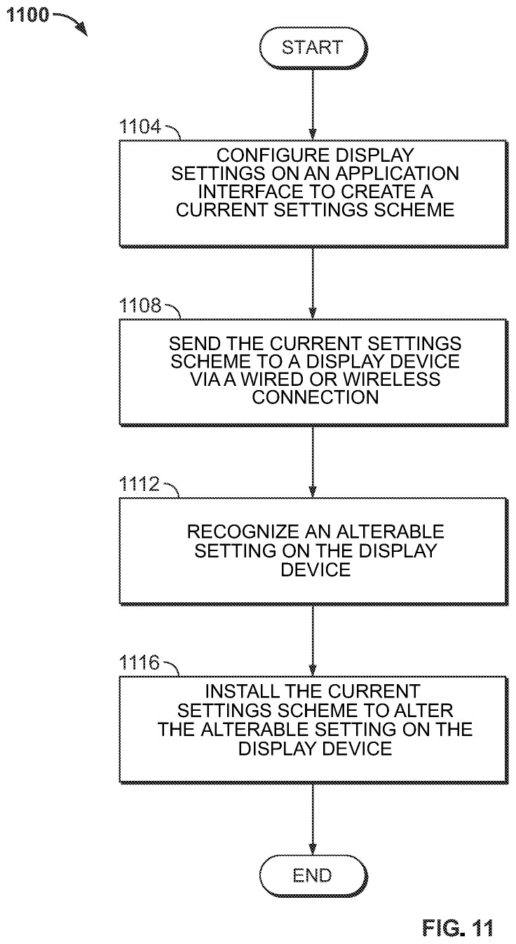

Referring now to FIG. 11, another example method 1100 is illustrated for updating a setting on a display device. At step 1104, the method 1100 includes configuring a display setting on an application interface to create a current settings scheme. At step 1108, the method 1100 includes sending the current settings scheme, in the form of a file containing machine-readable code, to an electronic device via a wired or wireless connection. At step 1112, the method 1100 includes recognizing an alterable setting on a display device. At step 1116, the method 1100 includes installing the current settings scheme (e.g., by executing the code) to alter the alterable setting on the display device.

Using such a display devices, methods, and machine-readable storage medium as described herein may, for example, provide greater control over display device functionality and power settings on an individual basis for individual customers as well as a large-scale basis for commercial customers to create an optimal user experience; comply with imposed power consumption regulations for different regions; and provide quicker options for updating settings (e.g., allowing for tens of seconds to update some or all settings via an application in accordance with implementations described herein versus tens of minutes to update settings through a firmware update). However, it is contemplated that the device, methods, and machine-readable storage medium disclosed herein may address other matters and deficiencies in a number of technical areas, for example.

Certain operations of methods according to the technology, or of systems executing those methods, can be represented schematically in the figures or otherwise discussed herein. Unless otherwise specified or limited, representation in the figures of particular operations in particular spatial order can not necessarily require those operations to be executed in a particular sequence corresponding to the particular spatial order. Correspondingly, certain operations represented in the figures, or otherwise disclosed herein, can be executed in different orders than are expressly illustrated or described, as appropriate for particular examples of the technology. Further, in some examples, certain operations can be executed in parallel, including by dedicated parallel processing devices, or separate computing devices that interoperate as part of a large system.

The disclosed technology is not limited in its application to the details of construction and the arrangement of components set forth in the following description or illustrated in the following drawings. Other examples of the disclosed technology are possible and examples described and/or illustrated here are capable of being practiced or of being carried out in various ways.

As used in the present specification and in the appended claims, the term, “controller” or “control circuitry” may include a processor and a memory device. The processor includes the circuitry to retrieve executable code from the memory and execute the executable code. As specific examples, the controller or control circuitry as described herein may include machine-readable storage medium, machine-readable storage medium and a processor, an application-specific integrated circuit (ASIC), a semiconductor-based microprocessor, and a field-programmable gate array (FPGA), and/or other hardware device.

As used in the present specification, the term “storage medium” may contain a machine-readable storage medium, or store machine-usable program code for use by or in connection with an instruction execution system, apparatus, or device, such as a processor. In the context of this disclosure, a computer-usable or computer-readable medium may be any medium that can contain, store, communicate, or transport the program for use by or in connection with the instruction execution system, apparatus, or device. The memory may take many forms including volatile and non-volatile memory. The computer-usable or computer-readable medium may be, for example, but not limited to, an electronic, magnetic, optical, electromagnetic, infrared, or semiconductor system, apparatus, or device. For example, the memory may include Random-Access Memory (RAM), Read-Only Memory (ROM), an erasable programmable read-only memory (EPROM or Flash memory), a portable compact disc read-only memory (CD-ROM), a portable computer diskette, a hard disk, optical memory disks, and magnetic disks, among others. The executable code may, when executed by the respective component, cause the component to implement the functionality described herein. The storage medium may include a single storage medium or multiple storage mediums. The storage medium can be an electronic, magnetic, optical, or other physical storage device that contains or stores executable instructions. The storage medium may be, for example, Random-Access Memory (RAM), an Electrically Erasable Programmable Read-Only Memory (EEPROM), a storage device, an optical disc, etc. The storage medium may be a non-transitory storage medium.

A plurality of hardware and software-based devices, as well as a plurality of different structural components can be used to implement the disclosed technology. In addition, examples of the disclosed technology can include hardware, software, and electronic components or modules that, for purposes of discussion, can be illustrated and described as if the majority of the components were implemented solely in hardware. However, in one example, the electronic based aspects of the disclosed technology can be implemented in software (for example, stored on non-transitory computer-readable medium) executable by a processor. Although certain drawings illustrate hardware and software located within particular devices, these depictions are for illustrative purposes. In some examples, the illustrated components can be combined or divided into separate software, firmware, hardware, or combinations thereof. As one example, instead of being located within and performed by a single electronic processor, logic and processing can be distributed among multiple electronic processors. Regardless of how they are combined or divided, hardware and software components can be located on the same computing device or can be distributed among different computing devices connected by a network or other suitable communication links.

As used herein in the context of computer implementation, unless otherwise specified or limited, the terms “component,” “system,” “module,” “block,” and the like are intended to encompass part or all of computer-related systems that include hardware, software, a combination of hardware and software, or software in execution. For example, a component can be, but is not limited to being, a processor device, a process being executed (or executable) by a processor device, an object, an executable, a thread of execution, a computer program, or a computer. By way of illustration, both an application running on a computer and the computer can be a component. Components (or system, module, and so on) can reside within a process or thread of execution, can be localized on one computer, can be distributed between two or more computers or other processor devices, or can be included within another component (or system, module, and so on).

1. A method for updating settings of a display device:
generating a machine-readable code corresponding to a first setting of the settings of the display device;
exporting the machine-readable code to a storage medium;
initiating import of the machine-readable code to the display device; and
executing the machine-readable code via control circuitry of the display device to update the first setting of the display device,
wherein generating the machine-readable code includes:
selecting a setpoint of the first setting through an interface on a host display, and
altering the first setting through an on-screen display of the host display device.

2-3. (canceled)

4. The method of claim 1, wherein the interface is associated with one of an on-screen display of the host display device, a software application on the host display device, and a web-based application accessed through the host display device.

5. The method of claim 1, wherein exporting the machine-readable code to the storage medium includes downloading the machine-readable code to the storage medium.

6. The method of claim 1, wherein the storage medium is selected from a list comprising: a USB device, an external hard drive, an electronic device storage medium, and a network storage.

7. The method of claim 6, wherein initiating import of the machine-readable code includes connecting the storage medium to the display device.

8. The method of claim 6, wherein initiating import of the machine-readable code includes sending the machine-readable code to the display device over a network.

9. The method of claim 1, wherein the machine-readable code includes a list of codes, wherein each code is associated with one of the settings.

10. A display device, comprising:
a display; and
a display control circuitry to:
generate an on-screen display through the display,
receive an input via the on-screen display,
update a setting associated with the display device based on the input,
generate a machine-readable code corresponding to the updated setting, and
export the machine-readable code to a storage medium,
wherein the machine-readable code is executable by a second display device to update a corresponding setting of the second display device.

11. The display device of claim 10, further comprising a port that provides a connection between the display control circuitry and the storage medium.

12. The display device of claim 10, further comprising a user interface that receives the input.

13. The display device of claim 12, wherein the user interface includes one of buttons and a touch-screen interface.

14. The display device of claim 10, wherein the display control circuitry further exports the machine-readable code to a network.

15. The display device of claim 10, wherein the machine-readable code is in a form of a text file.

16. The display device of claim 10, wherein generating the machine-readable code corresponding to the updated setting includes generating a feature code corresponding to a code associated with the updated setting.

17. A plurality of devices, comprising:
a host electronic device comprising a processor to:
receive an input corresponding to a current settings scheme,
generate a machine-readable code corresponding to the current settings scheme, and
export the machine-readable code to a storage medium; and
a recipient display device comprising:
a recipient display, and
control circuitry to:
import the machine-readable code, and
execute the machine-readable code to update a setting of the recipient display.

18. The plurality of devices of claim 17, wherein the storage medium is a physical external storage device.

19. The plurality of devices of claim 17, wherein the storage medium includes a network-based storage.

20. The plurality of devices of claim 17, wherein the processor executes an application on the host electronic device to receive the input, generate the machine-readable code, and export the machine-readable code.
